(19) United States
(12) Patent Application Publication
(10) Pub. No.: US 2020/0329378 A1
(43) Pub. Date: Oct. 15, 2020

(54) SPOOFING DETECTION DEVICE AND A SPOOFING DETECTION METHOD

(71) Applicant: Qatar Foundation for Education, Science and Community Development, Doha (QA)

(72) Inventors: Roberto Di Pietro, Doha (QA); Savio Sciancalepore, Doha (QA); Gabriele Oligeri, Doha (QA); Pietro Tedeschi, Doha (QA)

(21) Appl. No.: 16/821,494

(22) Filed: Mar. 17, 2020

Related U.S. Application Data
(60) Provisional application No. 62/822,443, filed on Mar. 22, 2019.

(51) Int. Cl. H04W 12/12

(52) U.S. Cl. CPC H04W 12/1204

(57) ABSTRACT

A spoofing detection device is provided. The spoofing detection device includes an antenna configured to receive a signal from wireless communication; a processor configured to extract at least one feature of the received signal; a storage configured to store a local signal feature; a detection circuit configured to compare the extracted feature from the received signal and the local signal feature. The detection circuit is configured to decide if the signal is a spoofed signal based on a result of comparison between the extracted feature from the received signal and the local signal feature.

### CROSS REFERENCE TO RELATED APPLICATION

The present application claims priority to U.S. Provisional Patent Application No. 62/822,443, filed Mar. 22, 2019, the disclosure of which is incorporated into this specification by reference in its entirety.

### BACKGROUND

Satellite positioning systems such as Global Positioning Systems (GPS) are rapidly being used for determination of the geocentric position of devices such as mobile phones, water and land vehicles, aircraft and survey equipment. An increasing amount of systems and technologies relies on use of positioning and navigation technologies to provide a wide range of services such as dedicated advertisement based on the location of the user, and position-based suggestions.

The devices using positioning and navigation technologies generally rely on signals from satellites. The signals may contain the time of the delivery, the frequency offset information and information useful to precisely reconstruct the travelled distance. The availability and reliability of those transmitted signals are important to guarantee high level of Quality of Service (QoS) and effective positioning suggestions.

The signals transmitted from the satellites are relatively weak in power due to the far distance between the satellites and the devices. Spoofed signals can be easily superimposed over the genuine signals and render the receiver or users devices to deviate from the real location or position. Thus, this could cause severe threats to the security and safety of users and availability of legitimate services.

Accordingly, it would be advantageous to provide better mechanisms for accurate, dynamic and efficient detection of spoofing.

### SUMMARY

The present disclosure generally relates to devices, systems, methods and solutions to detect spoofing of the positioning and navigation technologies such as the GPS technology, GALILEO, BeiDou, Global Navigation Satellites System (GLONASS) and others.

In light of the present disclosure, and without limiting the scope of the disclosure in any way, in an aspect of the present disclosure, which may be combined with any other aspect listed herein unless specified otherwise, a spoofing detection device is provided. The spoofing detection device includes an antenna configured to receive a signal from wireless communication; a processor configured to extract at least one feature of the received signal; a storage configured to store a local signal feature; a detection circuit configured to compare the extracted feature from the received signal and the local signal feature. The detection circuit is configured to decide if the signal is a spoofed signal based on a result of comparison between the extracted feature from the received signal and the local signal feature.

In an aspect of the present disclosure, which may be combined with any other aspect listed herein unless specified otherwise, the spoofing detection device alarms when the received signal is decided as a spoofed signal.

In an aspect of the present disclosure, which may be combined with any other aspect listed herein unless specified otherwise, the processor is configured to extract the at least one feature from a physical layer of the signal.

In an aspect of the present disclosure, which may be combined with any other aspect listed herein unless specified otherwise, the signal includes in-phase (I) and in-quadrature (Q) components.

In an aspect of the present disclosure, which may be combined with any other aspect listed herein unless specified otherwise, the extracted feature from the received signal includes at least one of amplitude information, frequency information, phase information, I-Q offset, quadrature skew and DC offset.

In an aspect of the present disclosure, which may be combined with any other aspect listed herein unless specified otherwise, the spoofing detection device verifies the signal as reliable signal when the extracted feature from the received signal matches with the local signal feature.

In an aspect of the present disclosure, which may be combined with any other aspect listed herein unless specified otherwise, the spoofing detection device is configured to be equipped on an aircraft.

In an aspect of the present disclosure, which may be combined with any other aspect listed herein unless specified otherwise, the spoofing detection device is configured to be equipped on an unmanned aerial vehicle.

In an aspect of the present disclosure, which may be combined with any other aspect listed herein unless specified otherwise, the spoofing detection device is configured to be equipped on a mobile device.

In an aspect of the present disclosure, which may be combined with any other aspect listed herein unless specified otherwise, a spoofing detection method is provided. The spoofing detection method includes obtaining a signal from wireless communication, extracting at least one feature of the received signal, comparing the extracted feature from the received signal and a pre-stored local signal feature, and determining whether the signal is a spoofed signal based on a result of comparison between the extracted feature from the received signal and the local signal feature.

In an aspect of the present disclosure, which may be combined with any other aspect listed herein unless specified otherwise, alarming when the received signal is decided as a spoofed signal.

In an aspect of the present disclosure, which may be combined with any other aspect listed herein unless specified otherwise, verifying the signal as reliable signal when the extracted feature from the received signal matches with the local signal feature.

In an aspect of the present disclosure, which may be combined with any other aspect listed herein unless specified otherwise, the spoofing detection method is configured to be used by an aircraft.

In an aspect of the present disclosure, which may be combined with any other aspect listed herein unless specified otherwise, the spoofing detection method is configured to be used by an unmanned aerial vehicle.

In an aspect of the present disclosure, which may be combined with any other aspect listed herein unless specified otherwise, the spoofing detection method is configured to be used by a mobile device.

The reader will appreciate the foregoing details, as well as others, upon considering the following detailed description of certain non-limiting embodiments of the system and method for spoofing detection of positioning and navigation technology according to the present disclosure.

### BRIEF DESCRIPTION OF THE DRAWINGS

Features and advantages of the systems and methods described herein may be better understood by reference to the accompanying drawing in which:

FIG. 1 is a schematic illustration of a spoofing detection device according to an embodiment of the present disclosure.

FIG. 2 is an illustration of a spoofing detection device provided on an aircraft according to an embodiment of the present disclosure.

FIG. 3 is an illustration of a spoofing detection device provided on an Unmanned Aerial Vehicle (UAV) according to an embodiment of the present disclosure.

FIG. 4 is an illustration of a spoofing detection device provided on a mobile device according to an embodiment of the present disclosure.

The reader will appreciate the foregoing details, as well as others, upon considering the following detailed description of certain non-limiting embodiments of devices, instruments and methods according to the present disclosure. The reader may also comprehend certain of such additional details upon using the devices, instruments and methods described herein.

### DETAILED DESCRIPTION

The present disclosure generally discloses devices, systems, methods and solutions of detecting spoofing of the positioning and navigation technologies such as GPS, GLONASS, GALILEO and BEIDOU.

Various embodiments of the disclosure are discussed in detail below. Certain embodiments such as aircraft, unmanned aerial vehicles (UAVs), intelligent vehicles and mobile devices as disclosed herein can be applied on a variety of devices leveraging positioning and navigation technologies. While specific implementations are discussed, it should be understood that this is done for illustration purposes only. A person skilled in the relevant art will recognize that other components and configurations may be used without parting from the spirit and scope of the disclosure.

The present disclosure provides devices, systems and methods for spoofing detection of position and navigation technology. The devices, systems and methods have a wide range of applications such as civil, military, advertisement and entertainment applications used in everyday activities. Nowadays, smartphones, automobiles, aerial vehicles, drones and the like run software applications requiring the precise knowledge of positioning and navigation information of the devices as well as timing information. Thus, having the assurance that location information and the timing information are genuine is important to guarantee the highest levels of quality of service and quality of experience.

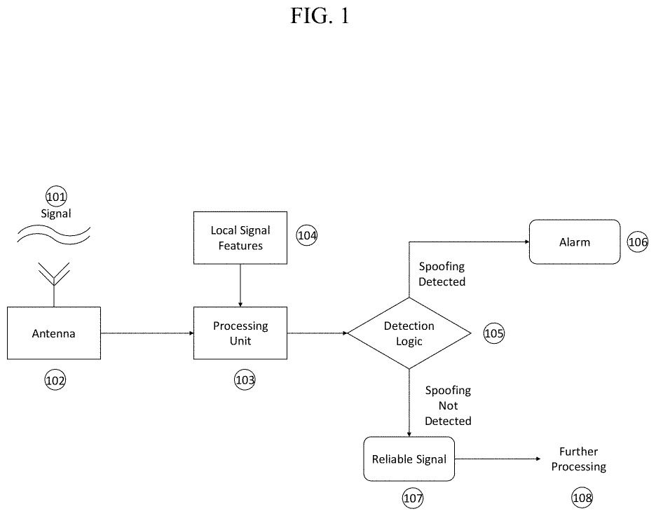

FIG. 1 illustrates a configuration of a spoofing detection device according to an embodiment of the present disclosure. The spoofing detection device includes an antenna 102, a processing unit 103 and a detection logic circuit 105. The spoofing detection device is able to detect the signals delivered on the operational frequency of the positioning and navigation technology via the antenna 102. The spoofing detection device may have a storage unit to store the signals received from outside. The signals 101 typically include an In-phase component signal, hereby referred as “I” component, and an In-quadrature component signal, hereby called “Q” component. The signals 101 are continuously acquired and analyzed for information referring to a specific positioning and navigation information. After a given acquisition time, the signals are passed to the processing unit 103. The processing unit 103 may include a CPU, a processor, a random access memory (RAM), a read on memory (ROM) or the like. The processing unit 103 may pre-store local signal features of the genuine signals received from trusted satellites. The local signal features may be pre-stored in the storage unit according to an embodiment of present disclosure. The storage unit may include a volatile memory such as random access memory (RAM) or a non-volatile memory such a read on memory (ROM). The storage unit may be an integrated part of the processing unit 103. The storage unit may be a separate part from the processing unit 103. The local signal features 104 may include typical range of amplitude, frequency, phase and non-idealities such as I-Q offset, quadrature skew, DC offset and the like. The processing unit 103 is configured to extract the particular features from the received signals 101 including but not limited to amplitude, frequency, phase and non-idealities such as I-Q offset, quadrature skew, DC offset and the like. The local signal features 104 of genuine signals from trusted satellites and the extracted features of the signal 101 are passed to the detection logic circuit 105. The detection logic circuit 105 may include a CPU, a processor, a random access memory (RAM), a read on memory (ROM) or the like. The detection logic circuit is configured to evaluate the level of similarity between the local signal features 104 and the extracted features of the received signal 101. If the detection logic circuit detects a consistent difference in comparison with the local signal features 104 and the extracted features of the received signal 101, then the detection logic circuit decides the received signal 101 is not genuine, and the spoofing situation is detected. An alarm is generated when the spoofing situation is detected. The alarm can be in a form of voice, vibration or flashing lights. On the other hand, if the comparison result shows that the extracted features of the received signal 101 matches with the local signal features, then the signal 101 is considered as genuine and reliable signal. The signal 101 is passed ahead for further processing when no spoofing situation is detected.

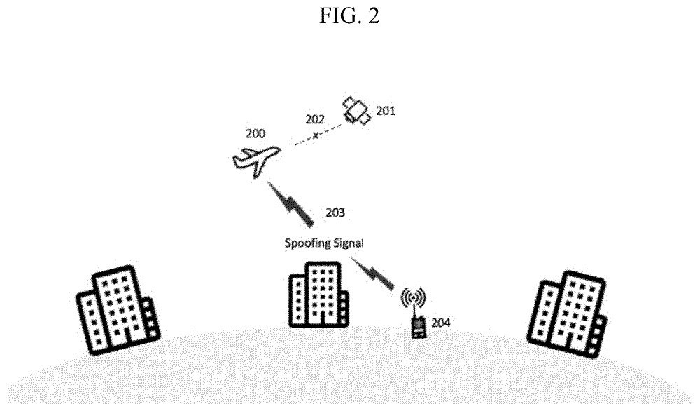

FIG. 2 illustrates a spoofing detection device provided on an aircraft according to an embodiment of the present disclosure. The aircraft 200 has a spoofing detection device with a similar configuration as the spoofing detection device as described in FIG. 1. A malicious device 204 is configured to emit spoofed signals to the aircraft 200. Therefore, the aircraft 200 may not be able to locate its current position information because the genuine signal 202 from the positioning and navigation satellite is spoofed by the malicious device 204. In order to verify whether the received signals are spoofed or not, the aircraft is equipped with the spoofing detection device. The spoofing detection device is configured to extract the features of the received signals, analyze the extracted features in comparison with the local signal features pre-stored in the spoofing detection device. If the spoofing detection device detects a consistent difference in comparison with the pre-stored local signal features and the extracted features of the received signal, then the received signal 203 is considered to be spoofed signal, and the position information based on the received signal 203 will be discarded because the received signal is not genuine signal from the trusted satellite 201. On the other hand, if the comparison results shows that the features are same or substantially similar, then the received signal is considered as genuine and reliable signal from the trusted satellite 201. The received signal is passed ahead for further processing to decide the position and navigation information.

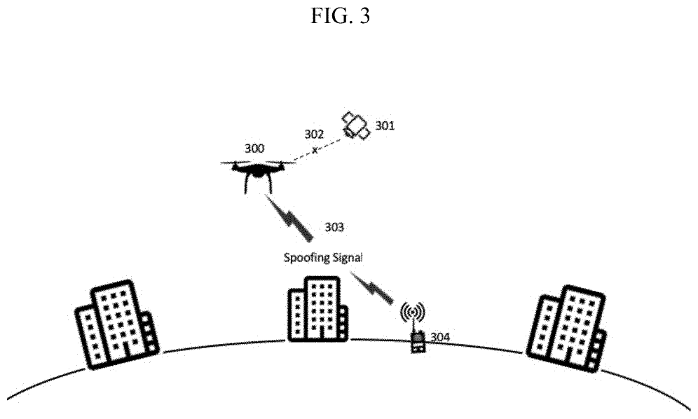

FIG. 3 illustrates a spoofing detection device provided on an Unmanned Aerial Vehicle (UAV) according to an embodiment of the present disclosure. The UAV 300 has a spoofing detection device with a similar configuration as the spoofing detection devices as described-above. A malicious device 304 is configured to emit spoofed signals to the UAV 300. Therefore, the UAV 300 may not be able to identify its correct location information because the genuine signal 302 from the trusted positioning and navigation satellite 301 is spoofed by the malicious device 304. In order to verify whether the received signals are spoofed or not, the UAV 300 is equipped with the spoofing detection device. The spoofing detection device is configured to extract the features of the received signals, analyze the extracted features in comparison with the local signal features pre-stored in the spoofing detection device. If the spoofing detection device detects a consistent difference in comparison with the pre-stored local signal features and the extracted features of the received signal, then the received signal 303 is considered to be spoofed signal, and the location information based on the received signal 303 will be discarded because the received signal is not genuine signal from the trusted satellite 201. On the other hand, if the comparison results shows that the features are same or substantially similar, then the received signal is considered as genuine and reliable signal from the trusted satellite 301. The received signal is passed ahead for further processing to decide the correct location and navigation information.

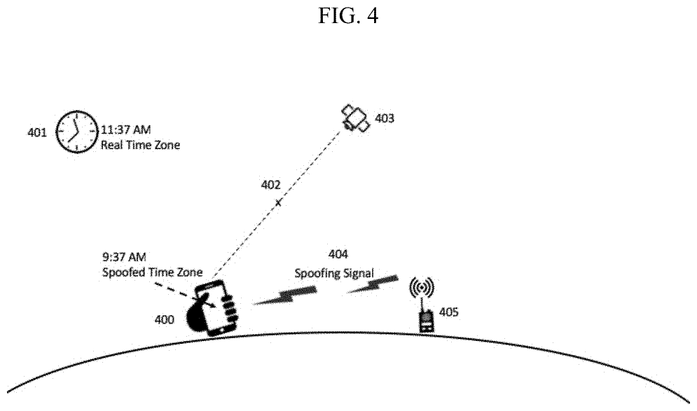

FIG. 4 illustrates a spoofing detection device provided on mobile device such as smartphone according to an embodiment of the present disclosure. The mobile device 400 includes a spoofing detection device with a similar configuration as the spoofing detection devices as described-above. A malicious device 405 is configured to emit spoofed signals to the mobile device 400 and disturb the synchronization with real time zone clock of the mobile device 400. The mobile device 400 may not be able to establish its reference clock and synchronize it with the real time zone clock 401 because the genuine signal 402 from the trusted positioning and navigation satellite 403 is spoofed by the malicious device 405. For example, the mobile device 400 may show a wrong reference clock at 9:37 AM based on the spoofed signal from the malicious device 405. However, the real time zone where the mobile device 400 locates is 11:37 AM if the genuine signal 402 is received from the trusted positioning and navigation satellite 403.

In order to verify whether the received signals are spoofed or not, the mobile device 400 is equipped or integrated with the spoofing detection device as described above. The spoofing detection device is configured to extract the features of the received signals, analyze the extracted features in comparison with the local signal features pre-stored in the spoofing detection device. If the spoofing detection device detects a consistent difference in comparison with the pre-stored local signal features and the extracted features of the received signal, then the received signal 404 is considered to be spoofed signal, and the time zone reference information based on the received signal 404 will be discarded because the received signal is not genuine signal from the trusted satellite 403. In this way, any timing attach from spoofed signals would be rejected. On the other hand, if the comparison results shows that the features are same or substantially similar, then the received signal is considered as genuine and reliable signal from the trusted satellite 301. The received signal is passed ahead for further processing to decide the correct time zone reference information.

According to an embodiment of the present disclosure, a method for spoofing detection is provided. The method including obtaining a signal from wireless communication, extracting a feature from the obtained signal, comparing the extracted feature with a pre-stored local feature of a genuine signal from a trusted source, and determine if the extracted feature matches with the re-stored local feature of the genuine signal. The method of spoofing detection is advantageous because it is very easy to be deployed aside of existing products or systems.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A spoofing detection device, comprising:
an antenna configured to receive a signal from wireless communication;
a processor configured to extract at least one feature of the received signal;
a storage configured to store a local signal feature;
a detection circuit configured to compare the extracted feature from the received signal and the local signal feature,
wherein the detection circuit is configured to decide whether the signal is a spoofed signal based on a result of comparison between the extracted feature from the received signal and the local signal feature.

2. The spoofing detection device according to claim 1, wherein the spoofing detection device alarms when the received signal is decided as a spoofed signal.

3. The spoofing detection device according to claim 1, wherein the processor is configured to extract the at least one feature from a physical layer of the signal.

4. The spoofing detection device according to claim 1, wherein the signal includes in-phase (I) and in-quadrature (Q) components.

5. The spoofing detection device according to claim 4, wherein the extracted feature from the received signal includes at least one of amplitude information, frequency information, phase information, I-Q offset, quadrature skew and DC offset.

6. The spoofing detection device according to claim 1, wherein the spoofing detection device verifies the signal as reliable signal when the extracted feature from the received signal matches with the local signal feature.

7. The spoofing detection device according to claim 1, wherein the spoofing detection device is configured to be equipped on an aircraft.

8. The spoofing detection device according to claim 1, wherein the spoofing detection device is configured to be equipped on an unmanned aerial vehicle.

9. The spoofing detection device according to claim 1, wherein the spoofing detection device is configured to be equipped on a mobile device.

10. A spoofing detection method, comprising:
obtaining a signal from wireless communication,
extracting at least one feature of the received signal,
comparing the extracted feature from the received signal and a pre-stored local signal feature, and
determining whether the signal is a spoofed signal based on a result of comparison between the extracted feature from the received signal and the local signal feature.

11. The spoofing detection method according to claim 10, further comprising alarming when the received signal is a spoofed signal.

12. The spoofing detection method according to claim 10, wherein the signal includes in-phase (I) and in-quadrature (Q) components.

13. The spoofing detection method according to claim 12, wherein the extracted feature from the received signal includes at least one of amplitude information, frequency information, phase information, I-Q offset, quadrature skew and DC offset.

14. The spoofing detection method according to claim 10, further comprising verifying the signal as reliable signal when the extracted feature from the received signal matches with the local signal feature.

15. The spoofing detection method according to claim 10, wherein the spoofing detection method is configured to be used by an aircraft.

16. The spoofing detection method according to claim 10, wherein the spoofing detection method is configured to be used by an unmanned aerial vehicle.

17. The spoofing detection method according to claim 10, wherein the spoofing detection method is configured to be used by a mobile device.
